(19) United States
(12) Patent Application Publication
(10) Pub. No.: US 2006/0218491 A1
(43) Pub. Date: Sep. 28, 2006

(54) System, method and program product for community review of documents

(75) Inventors: David J. Grossman, Duxbury, MA (US); Sean J. Martin, Boston, MA (US); Louis M. Weitzman, Brookline, MA (US)

Correspondence Address: John E. Campbell;IBM Corporation Intellectual Property Law, 2455 South Road - P386, Poughkeepsie, NY, 12601, US

(73) Assignee: International Business Machines Corporation, Armonk, NY (US)

(21) Appl. No.: 11/089,626

(22) Filed: Mar. 25, 2005

(51) Int. Cl. G06F 17/00

(52) U.S. Cl. 715/517

(57) ABSTRACT

A system, method and program product for providing for the review of documents by a community of interest having a computer accessible database of documents, a computer accessible database of annotations for recording annotations of selected documents in the database of documents, and a publication/subscription (Pub/Sub) infrastructure for publishing selected documents in the database of documents and annotations thereof to subscribers of the selected documents. A registration process registers members of the community of interest who have authority to view selected documents of the database of documents, to view and modify annotations of the documents through the Pub/Sub infrastructure.

### FIELD OF THE INVENTION:

This invention relates to tracking and adding contributions to analysis of documents in a data base and sharing such contributions to a community of interested individuals, and particularly to annotating and publishing analysis of patent documents to a community of inventors and patent attorneys.

### BACKGROUND OF THE INVENTION:

Currently, there is no way to track critical information about patents and related prior art or potential violations. In addition, there is no way for the community at large to contribute their expertise and provide information about either internal or external patents. For instance, if a researcher comes across an external patent and is knowledgeable about existing prior art, there is no way to record that information for the intellectual property attorneys. This would be extremely helpful if ever this patent becomes a legal issue for the corporation. Similarly there is no simple mechanism for recording with a patent owned by a corporation, information about a potential violation of that patent, in a manner that it is easily retrievable by the appropriate attorney who can look into the potential for licensing. Furthermore, it would be extremely effective to allow the community, whether an attorney or inventor, to sign up for updates to a given patent or area of patent interest. This system would leverage the corporate knowledge embodied in the individual experts of that company. Finally, such a system might be used by a team of attorneys either defending or prosecuting violation of any particular patent (or even if the corporation is simply deposed as a witness in such a case) as a shared resource for the collection of evidence and in collaboration with the knowledgeable experts (technical or witnesses to events) in that corporation. This invention uses a publish/subscribe infrastructure with a robust annotation system enabling the benefits mentioned.

U.S. Pat. No. 5,991,751 issued Nov. 23, 1999 to Rivette et al. for SYSTEM, METHOD AND COMPUTER PROGRAM PRODUCT FOR PATENT-CENTRIC AND GROUP-ORIENTED DATA PROCESSING discloses a system, method, and computer program product for processing data which maintains first databases of patents, and second databases of non-patent information of interest to a corporate entity. The system, upon receiving appropriate operator commands, automatically processes the patents in one of the groups in conjunction with non-patent information from the second databases.

U.S. Pat. No. 5,991,780 issued Nov. 23, 1999 to Rivette et al. for COMPUTER BASED SYSTEM, METHOD, AND COMPUTER PROGRAM PRODUCT FOR SELECTIVELY DISPLAYING PATENT TEXT AND IMAGES discloses a system, method, and computer program product for displaying a patent document and a patent image. A user interface selectively displays the patent text file and the patent image file on a display such that at least a portion of the patent text file is displayed in a first window and at least a portion of the patent image file is displayed in a second window, and the windows may be selectively viewed simultaneously or individually on the display.

U.S. Patent Application Publication US 2002/0161733 A1 published Oct. 31, 2002 by Grainger for METHOD OF CREATING ELECTRONIC PROSECUTION EXPERIENCE FOR PATENT APPLICANT discloses a method of managing documents related to a patent application. The method includes generating an invention disclosure from a first client system coupled to an invention disclosure where the first client system is associated with a first technology developer, storing the generated invention disclosure in a database accessible to the server system, drafting a patent application for the invention disclosure from a second client system coupled to the server system, where the second client system is associated with a patent practitioner, and storing the drafted patent application in a database.

U.S. Patent Application Publication US 2002/0184130 A1 published Dec. 5, 2002 by Blasko for INTELLECTUAL CAPITAL RISK ANALYSIS SYSTEM discloses a system, method and computer program product wherein a first database having data patent and patent application information, a second data base for storing information related to risk elements associated with the acquisition of inventions, and evaluating certain risks associated with a patent application, a group of patent application, a patent and/or group of patents to determine the risk level.

U.S. Patent Application Publication US 2002/0019836 A1 published Feb. 14, 2002 by Uchio et al. for INFORMATION PROCESSING APPARATUS FOR MANAGEMENT OF DOCUMENTS RELEVANT TO PATENT APPLICATION discloses an information processing apparatus for efficiently managing documents and various procedures related to a patent application. Information related to a patent application is accumulated in a database. When an inventor has to study a case, a request is issued to the inventor through a network, and the state of the study by the inventor is checked through the network.

U.S. Patent Application Publication US 2002/0022974 A1 published Feb. 21, 2002 by Lindh for DISPLAY OF PATENT INFORMATION discloses a method for obtaining patent information across a multitude of databases, categorizing the information and displaying the information.

U.S. Patent Application Publication US 2002/0035499 A1 published Mar. 21, 2002 by Gernewraad et al. for PATENT-RELATED TOOLS AND METHODOLOGY FOR USE IN THE MERGER AND ACQUISITION PROCESS discloses patent-related tools and methodologies involving those tools, for assisting in all stages of the merger and acquisition process. The features of the tools include document annotation.

U.S. Patent Application Publication US 2002/0073095 A1 published Jun. 13, 2002 by Ohga for PATENT CLASSIFICATION DISPLAYING METHOD AND APPARATUS discloses a method for displaying the classification of a patent document to which multi-viewpoint patent classifications are added.

U.S. Patent Application Publication US 2003/0101197 A1 published May 29, 2003 by Sorensen et al. for MANAGEMENT OF IDEAS ACCUMULATED IN A COMPUTER DATABASE discloses various methods of managing ideas, inventions and contractual obligations for those ideas and inventions.

U.S. Patent Application Publication US 2003/0220897 A1 published Nov. 27, 2003 by Lee et al. for SYSTEM AND METHOD FOR PROCESSING AND ANALYZING PATENT INFORMATION discloses a system for processing and analyzing patent information. A user selects an analysis type and defines conditions of analysis, which can include selecting aggregation and combination of patent information of different patent offices in various languages for analysis.

U.S. Patent Application Publication US 2004/0044688 A1 published Mar. 4, 2004 by Brudz et al. for PATENT ASSET MANAGEMENT SYSTEMS AND METHODS discloses a method for managing patent asset information for a business entity using a server system coupled to a centralized database and a least one client system.

### SUMMARY OF THE INVENTION:

The shortcomings of the prior art are overcome and additional advantages are provided through the use of three separate technologies. One is the ability to “annotate” individual documents (e.g., patents) with comments, expertise and prior art or possible violations. In this example, these annotations could include (but not be limited to) the actual prior art documents, time of publication, comments on the validity of the patent, URL links or attached documentation for products/services that might be in violation of that patent etc. These annotations would then be available to other members of the corporate community and intellectual property law departments whenever information about a topic or specific patent would be needed or as a regular query for potential licensees of patents. The second technology is to utilize a publish/subscribe infrastructure to allow members of the community to subscribe to updates to a particular document (e.g., patent) or area of interest (category of information). These channels of information would form communities of interest. In this way, members of an area of interest (which could be as small as those interested in a specific patent—for example the inventors and their consulting attorney) would be notified when new annotations or any activity or event surrounding that document or area of interest occur. In addition, messages to the community could be sent by the legal team to request additional help at any given time. The third technology is the use of full text databases that provides access to the actual patents through a subscription service.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS:

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a block diagram of a system of the present invention including a network having a patent databases, an annotation database, and a subscription/publication infrastructure, a user, and a community of interest;

FIG. 2 illustrates the flow of interaction between the user and the system during the annotation creation process;

FIG. 3 is an example of a registration form for registering of a requester for receiving alerts for particular patents or topics;

FIG. 4 is an illustration of a registration form for registering an authorized individual to make or modify an annotation in the annotation database, and to be contacted if any issues regarding a topic or patent arises;

FIG. 5 is an illustration of a prior art/infringement annotation document which is used to enter an annotation into the annotation database;

FIG. 6 is an illustration of an opportunities/extensions document which is used to identify opportunities where an existing patent could be extended or an idea variation that could be used to create possible new inventions; and

FIG. 7 is a block diagram showing the flow for viewing by a user of an existing patent document in the patent database and having the system automatically provide annotations for that patent from the annotation database.

The detailed description explains the preferred embodiments of the invention, together with advantages and features, by way of example with reference to the drawings.

### DETAILED DESCRIPTION OF THE INVENTION

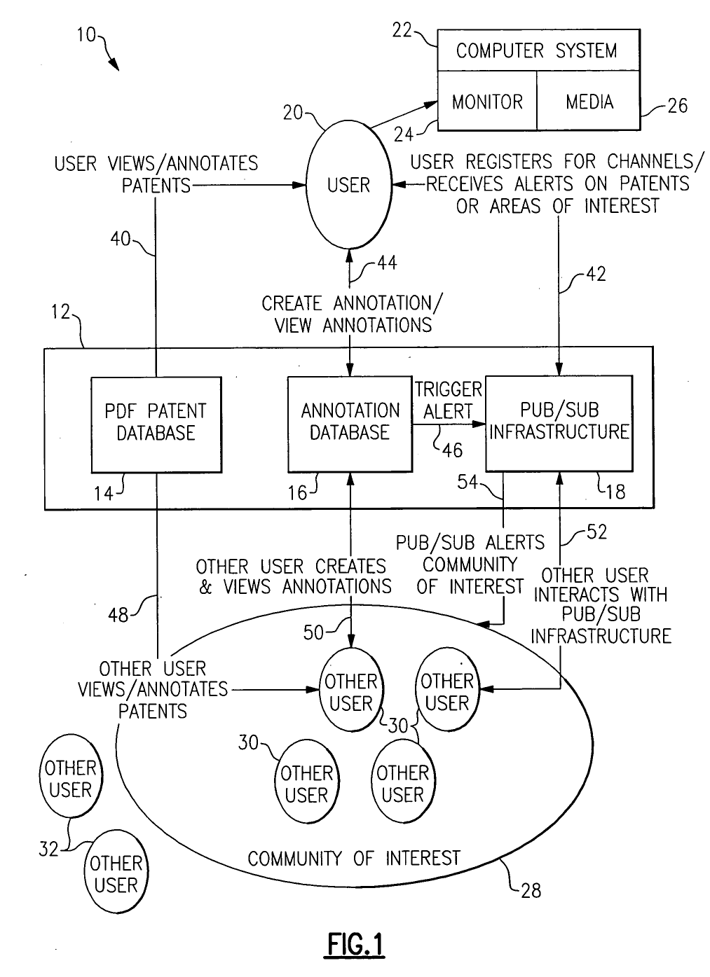

FIG. 1 is a block diagram of a system 10 of the present invention including a collection of databases and infrastructure (hereinafter collection) 12 in, for instance, a network, a user 20, a computer system 22 usable by the user 20, and a community of interest 28. The collection 12 includes a PDF patent database 14, an annotation database 16, and a Publication/Subscription (Pub/Sub) infrastructure 18. The user computer system 22 includes a monitor 24 for the user to view and interact with the computer 22 and the databases 14, 16 and 18, and a media 26 for storing computer readable data and programs of computer instructions, as is well understood in the art. It will be understood that the computer media 26 may be computer memory, computer tape, disk, diskettes, computer disk (CD), or any combination, as is well understood in the art. It will be understood that the network 12 includes a computer system having a monitor and media similar to that of computer system 22.

The collection 12 may be on a single computer system, a network of computers, servers in the Internet, or any combination, which is well understood. The patent database 14 may be any of a number of available databases, and preferably includes full text as well as illustrations. One such database is the Delphion patent database available from Thomson Delphion of Lisle, Illinois. The annotation database 16 may be databases such as handled by the InsightLink product available from International Business Machines Corp. (IBM) of Armonk, N.Y., and as described in U.S. Pat. No. 6,519,603 B1 issued Feb. 11, 2003 to Bays et al. for METHOD AND SYSTEM FOR ORGANIZING AN ANNOTATION STRUCTURE AND FOR QUERYING DATA AND ANNOTATIONS and U.S. patent application Ser. No. 10/759965 filed Jan. 16, 1004 for SYSTEM AND METHOD FOR TRACKING ANNOTATIONS OF DATA SOURCES, owned by the assignee of the present invention and incorporated herein by reference. The Pub/Sub infrastructure 18 is handled by the Gryphon and MQSeries products of IBM. Gryphon functionality is available in IBM WEBSPHERE available from IBM particularly in the component IBM WEBSPHERE MQEVENT BROKER also available from IBM. Gryphon provides a new alternative to subject-based systems and is a content-based messaging system. Functionality associated with Gryphon can be found in the following US patents: U.S. Pat. No. 6,216,132 “METHOD AND SYSTEM FOR MATCHING CONSUMERS TO EVENTS” (Chandra et al.); U.S. Pat. No. 6,091,724 “ROUTING MESSAGES WITHIN A NETWORK USING THE DATA CONTENT OF THE MESSAGE” (Chandra et al.); U.S. Pat, No. 6,336,119 “METHOD AND SYSTEM FOR APPLYING CLUSTER-BASED GROUP MULTICAST TO CONTENT-BASED PUBLISH-SUBSCRIBE SYSTEM” (Banavar et al.). Each of these patents is assigned to IBM and incorporated herein by reference.

The user 20 views a patent in the patent database and add annotations to the patents as shown at 40. The annotations for the patents are created and the annotations are viewed at 44 by the user 20. Finally, the user 20 registers for channels and receives alerts on patent or areas of interest by interacting with the Pub/Sub infrastructure 18 as shown at 42. Trigger alerts 46 are used by the annotation database 16 to alert the Pub/Sub infrastructure 18 when the user 20 or other users (to be discussed) are to be alerted of annotations available or modified in the annotation database 16 for patents of interest.

The community of interest 28 is made up of other users 30 which are included in the community 28 because of interest in selected ones of the patents and their annotations. It will be understood that each other user 30 also has a computer system such as 22, but which are not shown. There may be other users 32 which are not included in the community of interest, but which may be included in other communities of interest, based on selected patents or subject matter.

The typical user of the present invention ranges from inventor, to legal counsel, to licensing executive, to corporate executive. Depending on access rights, each user can create new annotations, view existing annotations created by others within the organization, or subscribe to documents, or topics, that are of interest. Any activity related to one of the areas of interest would then be received via the Sub/Pub infrastructure 18.

The patent pdf documents are published in the patent database and made accessible to the subscribed users. These documents can then be viewed by the community of users. If any annotations exist for a particular patent document, they will be made visible to a viewer. This is a standard feature of the annotation system. In the System 10 if FIG. 1, the annotations are not only viewed, but new annotations are created and stored back into the centralized database of annotations. These new annotations are then accessible to the rest of the community. Access controls can be put on the annotations so only a defined subset of the community could view the annotations. The forms for creating the annotations are created when the system is installed and initialized the first time. Then, only if changes are needed to those forms, would they be modified by a system administrator.

The publish/subscribe infrastructure allows for triggers to occur when certain events happen within the system. For example, when an annotation is created or modified, an event would occur that would generate the notification to those users subscribed to a particular topic. Then, only those users that are interested in that change are notified. This interest is defined by “subscribing” to topics and is a standard feature of publish/subscribe systems. Thus, the types of “topics” one could subscribe to include, a particular patent, a particular author, a general area of interest (which is defined by a hierarchy of topics defined for this application). For instance, if there is a topic on software and subtopics on user interfaces and algorithms, the user could subscribe to just the subtopic of user interfaces and only see patents that have been categorized in that more specific area and would not be interrupted by annotations on patents in the area of algorithms or any other classification in the system. This allows the user to see only those patents in their area of interest.

The process of publishing a notification sends the information to the subscribed user to see the patent that was annotated and who did the annotation. In addition, a summary could be provided as well as a link that would immediately launch a viewer to see the annotation in the context of the patent.

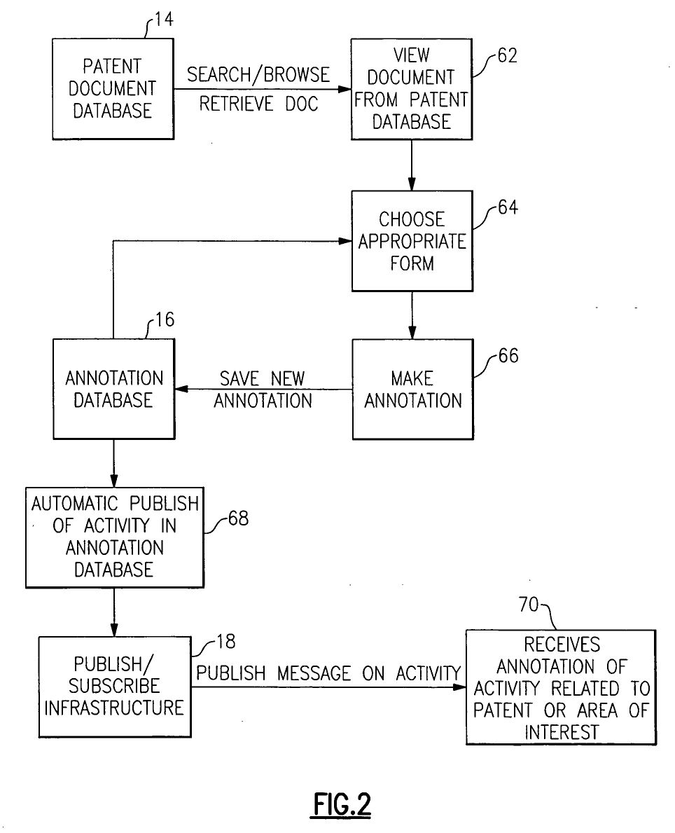

FIG. 2 illustrates the flow of the interaction between the user 20 and the system 10 during the annotation creation process. The patent document database 14 is subject to search, browse and retrieve document commands by a user to view a document from the patent database illustrated at 62. The user then may choose the appropriate form at 64 to make or update annotations from the annotation database 16. If the annotation is being updated, the annotation filed in the annotation database 16 is retrieved. The annotations are then made at 66 and the new annotation is then saved to the annotation database 16.

The activity of the annotation database is automatically published at 68 via the Publish/Subscribe infrastructure 18. Using the infrastructure 18, a message is published to the community of interest 28 on the annotation activity. At 70, the community of interest receives annotation of activity related to the patent or area of interest.

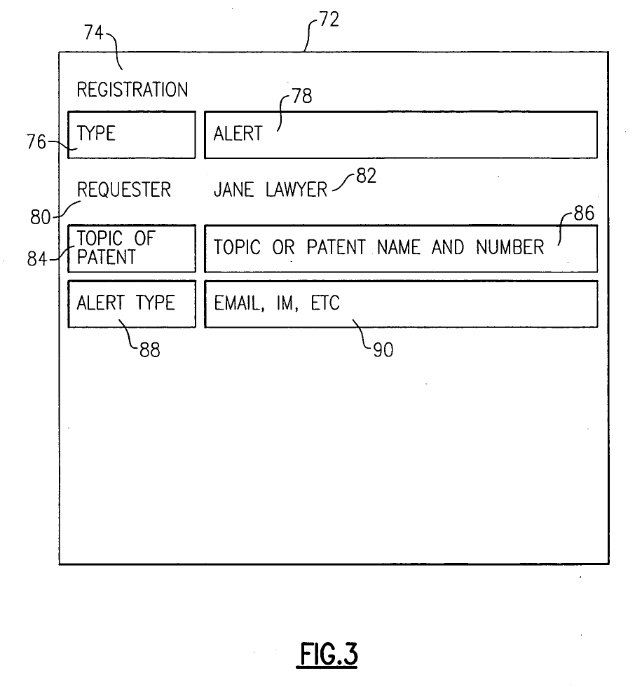

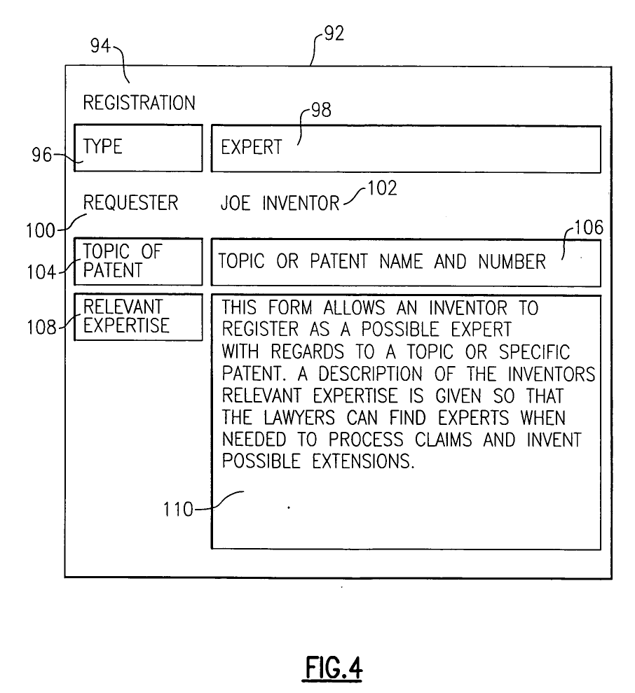

FIGS. 3-6 illustrate a number of forms used by the system to register for different types of alerts within the system, and to create or modify annotations on existing documents in the system. FIG. 3 is an example of a registration form 72 which is used for registering of a requester, such as an attorney, licensing executive, or corporate executive, for receiving alerts for particular patents or topics. The form 72 is identified as a registration form 74 to the system for registering the named individual. A type field 76 indicates that the identified individual should receive alerts 78. Other types may be identified by the type field 76, as will be discussed in connection with FIG. 4. The requester field 80 is used to identify the individual, such as by name, 82 for receiving the requested alerts. It will be understood that security schemes, such as passwords or other means for allowing only specified persons to register for alerts, may be used to limit access to annotations. The topic or patent field 84 is used to put in a search term 86 such as a topic identification, a patent name and/or number, or other terms, such as U.S. Patent Office Classification Numbers, International Classification Numbers, etc. to establish community of interest for the individual identified in the requester field 76. The alert type field 88 is used to identify the communication method to transmit alerts, such as email, instant messaging, or other means to be used by the system to deliver alerts to the requester.

FIG. 4 is an illustration of a registration form 92 for registering an individual as an expert for a particular patent or a general category (community of interest) to be contacted if any issues regarding a topic or patent arises. The form 92 is identified as a registration form 94 and includes a type field 96 for identifying the type of registration 98 to be saved within the system. The identifier expert 98 might be broken down further as a legal expert or a technical expert. The requester field 100 is used to enter the name, password, or other identification 102 into the field 100. The topic or patent field 104 is used to enter keywords, such as the topic or patent name or number, or other identifier to designate the community of interest. The relevant expertise filed 108 is used to describe the registering individual either as in inventor or other technical or legal expert as a possible expert with regards to this topic or specific patent. A description of the expert's relevant expertise is given so that the registration authority, such as a lawyer or lawyers, can find experts when needed to process, in the case of patents, claims and invent possible extension to the topic, or to create or modify annotations to the patents or topics of interest. It will be understood that not all requesters submitting form 92 will be registered, but only those approved by the registration authority as being qualified as a technical or legal experts. This identification may be used at a later time to call on individuals for their technical/legal expertise for a particular patent or particular category or community of interest.

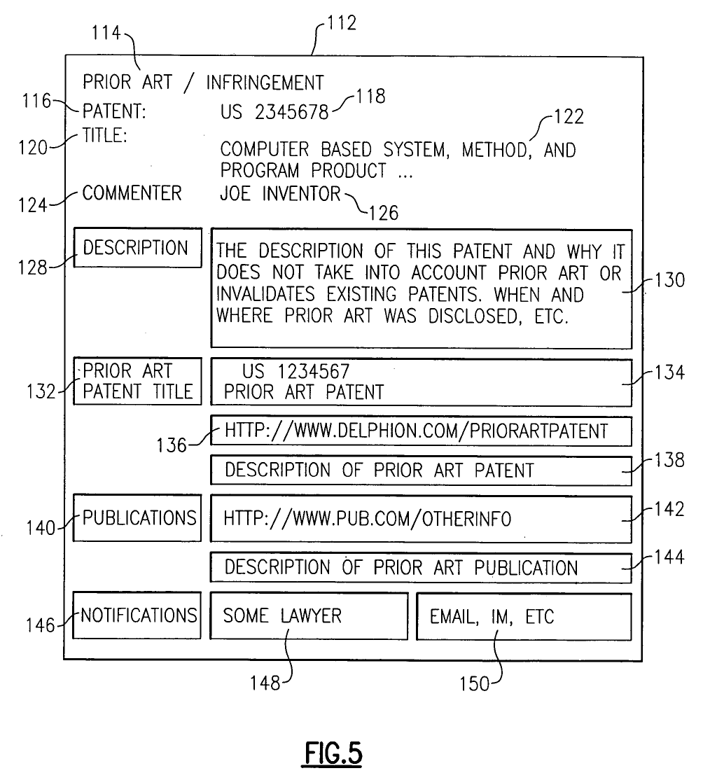

FIG. 5 is an illustration of a prior art / infringement annotation document 112 which is used to enter an annotation into the annotation database 16. The document 112 is identified as a prior art/infringement document by document 114. The patent number 116 field 116 and title field 120 are used to identify the patent number 118 and title 122 of the patent to be annotated. The commenter field 124 is used to enter the name 126 of the commenter. The commenter has been previously registered by the system. The description field 128 is used to enter a description of the patent 130 to include a description of the patent 1 18 and why it does not take into account prior art or how it might invalidate another existing patent or patents. Also enclosed may be identification of when and where the prior art is disclosed, or other information. The prior art and patent title field 132 is used to enter the patent number and title of a prior art patent. The location of the prior art patent is entered at 136, and a complete description of the prior art is entered at 138. It will be understood that prior art discussed in connection with form 112 of FIG. 5 may include more than patents, and may include journal articles, text books, instruction manuals, scientific reports, etc. The publications field 140 is used to enter the location 142 of these other types of prior art publications as well as the title, author's names, etc. to identify prior art publications. A description of the prior art publication is entered at 144. The notifications field 146 includes the names of reviewers 148 and the address, such as email, instant messaging (IM) addresses, etc. used to inform the reviewers of the annotation. These reviewers receiving notifications may be the same as those registered by registration 72 of FIG. 3, or may be additional reviewers known to the commenter 126, or some combination.

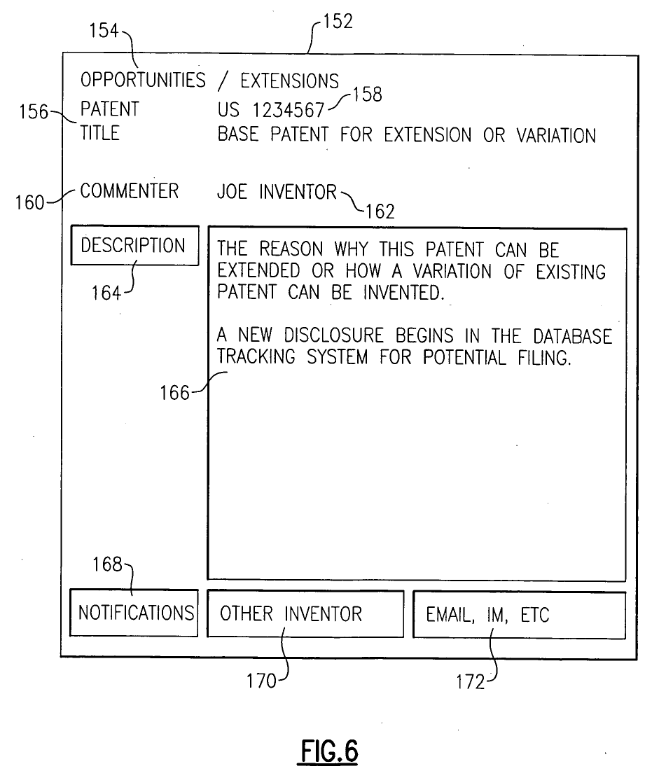

FIG. 6 is an illustration of an opportunities/extensions document 152 which is used to identify opportunities where an existing patent could be extended or an idea variation that could be used to create possible new inventions. Form 152 is identified by the title Opportunities/Extensions 154. A patent and title fields 156 are used to enter the patent number and title 158 of the subject patent. The commenter field 160 is used to enter the name 162 of the commenter or inventor of the suggested extension. A description field 164 enters a description of the reason this patent 158 can be extended or how a variation of existing patent can be invented. The description field may also be used to begin an invention disclosure database tracking system, along with recording the names of inventors and critical dates, as desired. The notifications field 168 is used to include the names of other inventors 170 who are collaborating with the proposed invention, and their email, IM, or other addresses. The opportunities/extension document 152 may also be used by licensing executives to annotate the patent 158 of licensing opportunities or possible licensees, and to notify others of the opportunities.

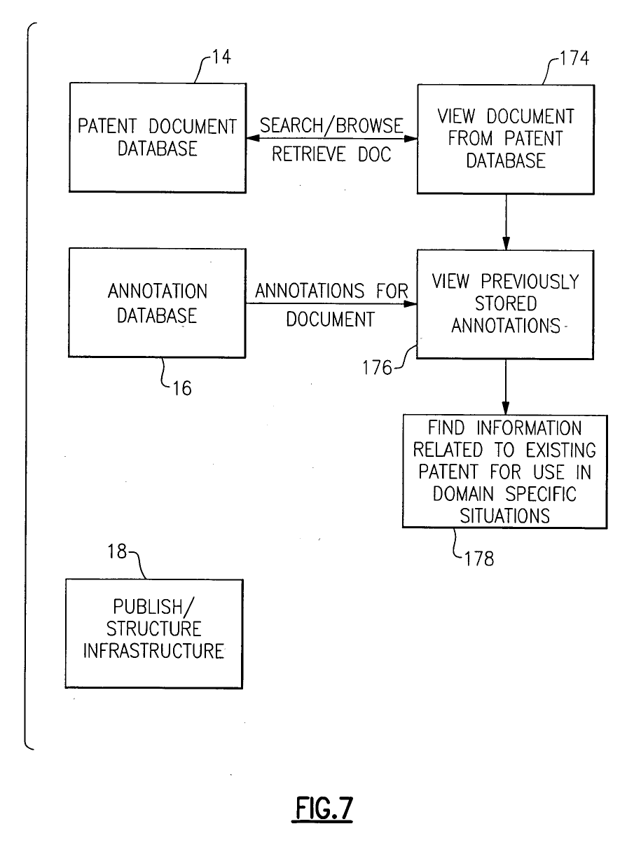

FIG. 7 is a block diagram showing the flow of viewing by a user of an existing patent document in the patent database and having the system automatically provide annotations for that patent from the annotation database 16. At 174, a user performs a search or browse process to retrieve a patent document from the patent database 14. At 176, the system automatically retrieves from the annotation database 16 annotations for that patent document. At 178, the user finds information related to existing patent for use in domain specific situations, such as prior art, validity studies, or possible extensions and opportunities as entered by the documents 112 and 152 of FIGS. 5 and 6.

It will be understood that even though a patent database is used in the present embodiment, the present invention may be used in connection with other domains. For instance the database 14 may be used for documents for design decision tracking, manufacturing, scientific journals, or in any other system wherein comments, critiques or evaluations are maintained in an annotation database 16 and which relate to documents in the database 14. One application is use by universities which publish scholarly articles subject by peer review. The articles themselves are placed in the database 14, and peer review comments placed in the annotation database 16. The peer reviewers may be selected by the university, and annotations may be restricted to only selected reviewers by giving access to the annotation database 16 by only selected reviewers. Also, access to the annotation database might be given to a range of reviewers so that official reviews might be given to only selected reviewers, another class of reviewers might be to other, public interest reviewers. Other might be given access to the annotation database 16 to view only, but not given write or rewrite authority. Another application is for producers or manufacturers of a product documented in a document database 14 to invite public comments to be added to an annotation database 16 discussing the product. Such applications may include book reviews, movie reviews, etc.

The capabilities of the present invention can be implemented in software, firmware, hardware or some combination thereof.

As one example, one or more aspects of the present invention can be included in an article of manufacture (e.g., one or more computer program products) having, for instance, the mentioned computer usable media 26 and the media of the other users 30 and the network 12. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A system for providing for the review of documents by a community of interest comprising:
a computer accessible database of documents;
a computer accessible database of annotations for recording annotations of selected documents in said database of documents; and
a publication/subscription (Pub/Sub) infrastructure for publishing selected documents in said database of documents and annotations thereof to subscribers of the selected documents.

2. The system according to claim 1 further comprising a registration process for registering members of the community of interest who have authority to view selected documents of said database of documents along with annotations thereof through said Pub/Sub infrastructure.

3. The system according to claim 2 further comprising a registration process for registering commenters to add annotations in said database of annotations for selected documents in said database of documents.

4. The system of claim 1 wherein said documents in said database of document are patent documents.

5. The system of claim 4 wherein said database of annotations includes annotations which describe prior art of selected patents in said database of documents.

6. The system of claim 4 wherein said database of annotations includes annotations which describe opportunities or extensions of selected patents in said database of said documents.

7. A method for providing for the review of documents by a community of interest comprising:
providing documents in a computer accessible database;
providing annotations in a computer accessible database for recording annotations of selected documents in said database of documents; and
publishing selected documents in said database of documents and annotations thereof to subscribers of the selected documents with a publication/subscription (Pub/Sub) infrastructure.

8. The method according to claim 7 further comprising registering members of the community of interest who have authority to view selected documents of said database of documents along with annotations thereof through said Pub/Sub infrastructure.

9. The method according to claim 8 further comprising registering commenters to add annotations in said database of annotations for selected documents in said database of documents.

10. The method of claim 9 further comprising entering patent documents into said database of document.

11. The method of claim 10 further comprising entering annotations into said database of annotations which describe prior art of selected patents in said database of documents.

12. The method of claim 10 further comprising entering annotations into said database of annotations which describe opportunities or extensions of selected patents in said database of said documents.

13. A program product usable with a system for providing for the review of documents by a community of interest, said program product comprising:
a computer readable medium having recorded thereon computer readable program code performing the method comprising:
providing documents in a computer accessible database;
providing annotations in a computer accessible database for recording annotations of selected documents in said database of documents; and
publishing selected documents in said database of documents and annotations thereof to subscribers of the selected documents with a publication/subscription (Pub/Sub) infrastructure.

14. The program product according to claim 13 wherein the program product further comprises registering members of the community of interest who have authority to view selected documents of said database of documents along with annotations thereof through said Pub/Sub infrastructure.

15. The program product according to claim 14 wherein the program product further comprises registering commenters to add annotations in said database of annotations for selected documents in said database of documents.

16. The program product of claim 15 wherein the program product further comprises entering patent documents into said database of document.

17. The program product of claim 16 wherein the program product further comprises entering annotations into said database of annotations which describe prior art of selected patents in said database of documents.

18. The program product of claim 16 wherein the program product further comprises entering annotations into said database of annotations which describe opportunities or extensions of selected patents in said database of said documents
